(19) United States
(12) Patent Application Publication
(10) Pub. No.: US 2014/0190326 A1
(43) Pub. Date: Jul. 10, 2014

(54) Effort-saving paper punch

(71) Applicant: Koc-Sing CO, KOWLOON (HK)

(72) Inventor: Koc-Sing CO, KOWLOON (HK)

(21) Appl. No.: 13/735,036

(22) Filed: Jan. 7, 2013

(51) Int. Cl. B26D 5/10; B26F 1/38

(52) U.S. Cl. CPC B26D 5/10; B26F 1/38
USPC 83/522.15; 83/618

(57) ABSTRACT

An effort-saving paper punch includes a lever pivot in position in relation to the lever, a lever pivot slot which receives the lever pivot in a way which enables the lever pivot to move towards the punching end in the resting position and away from the punching end in the punching position, and a longitudinal contact member which is fixedly disposed underneath the lever at a position corresponding to the punching members so that a first end of the longitudinal contact member which is farther away from the punching end abuts against the punching members in the resting position, and a second end of the longitudinal contact member which is nearer to the punching end abuts against the punching members in the punching position.

### BACKGROUND OF THE INVENTION

The present invention relates to paper punches and more specifically pertains to an effort-saving paper punch.

A paper punch is a device normally used to create holes in sheets of paper. It is commonly known that more force is needed for punching more sheets of paper, so there is always a great limitation on the number of sheets of paper that can be punched at one time. Much effort has been made previously to solve this problem. For example, an additional lever arm is provided to increase the mechanical advantage in some paper punches. It is true that such paper punches reduce the force needed to punch paper, but the complex structures involve increased material and production costs. Bulky and clumsy designs may also deter customers from buying.

### BRIEF SUMMARY OF THE INVENTION

In view of the aforesaid disadvantages, it is an object of the present invention to provide a paper punch which is effort-saving and simple in structure, thereby reducing material and production costs.

To attain this, the paper puncher of present invention comprises:

a base with a plurality of punching holes disposed towards a punching end;

a plurality of spring-loaded punching members disposed corresponding to the plurality of punching holes;

a pair of vertical supports mounted on the base;

a lever pivotably connected to the pair of vertical supports by means of a lever pivot to pivot between a resting position and a punching position, and the lever pivot is fixed in position in relation to the lever;

characterized in that:

a lever pivot slot is provided at each of the vertical supports for receiving the lever pivot in a way which enables the lever pivot to move towards the punching end in the resting position and away from the punching end in the punching position;

a longitudinal contact member is fixedly disposed underneath the lever at a position corresponding to the punching members so that a first end of the longitudinal contact member which is farther away from the punching end abuts against the punching members in the resting position; and as the lever pivots from the resting position to the punching position, the first end of the longitudinal contact member moves farther away from the punching end until a second end of the longitudinal contact member which is nearer to the punching end abuts against the punching members in the punching position.

In one embodiment, the longitudinal contact member may be in form of a U-shaped depression on the lever; alternatively, the longitudinal contact surface may be in form of a U-shaped bracket mounted underneath the lever. The longitudinal contact member may be in form of an integral element with its lateral length sufficient to cover all punching members; alternatively, the longitudinal contact member may be in form of separate elements, each of which has a lateral length sufficient to cover one of the punching members.

The lever slot is slanted with its lower end disposed nearer the punching end of the paper puncher and its upper end disposed farther from the punching end of the paper puncher.

In addition, each of the punching members is horizontally adjustable in position; more specifically, each of the punching members comprises a spring-loaded punch, a bracket for receiving the punch and allowing the punch to move vertically for punching, and a fastening member removably attached to the bracket and slidable along a horizontal guiding slot provided on a guiding plate mounted on the base for moving the punching member along the horizontal guiding slot; the punching holes on the base are configured correspondingly to allow the punching members to punch at any possible positions. In one embodiment, the fastening member may be in form of a screw. The guiding plate is preferably provided with dimensional markers to indicate corresponding punching positions.

In one specific embodiment, three punching members are provided; the punching member in middle is horizontally slidable between an operational position and a non-operational position; the longitudinal contact member is configured to abut against the punching member in middle when the punching member in middle is in the operational position, and not to abut against the punching member in middle when the punching member in middle is in the non-operational position.

The operation of the paper punch is as follows:

When the paper punch is in the resting position, the longitudinal contact member is disposed with its first end abutting against the top of the punching members, whereas the lever pivot is located at one end of the lever pivot slot which is nearer to the punching end. According to the lever principle, fulcrum is located at the position of the lever pivot (A), load is located at the point of contact between the first end of the longitudinal contact member and the punching members (B), and effort is located at the lever end (C). Mechanical advantage is the ratio of the distance between fulcrum and effort (AC) to the distance between fulcrum and effort (AB), that is, AC/AB.

To start punching, the user presses the lever end so that the lever moves downwards to the punching position. As the lever moves downwards, the lever pivot is driven to move away from the punching end towards the other end of the lever pivot slot. As the lever pivot is fixed in position in relation to the lever, and the longitudinal contact member is fixedly disposed underneath the lever, the longitudinal contact member accordingly moves away from the punching end until the second end of the longitudinal contact member abuts against the punching members. The punching members at this time pass through the punching holes and holes are punched on the sheets of paper. In the punching position, fulcrum is located at the position of the lever pivot (A′), load is located at the point of contact between the second end of the longitudinal contact member and the punching members (B′), and effort is located at the lever end (C). In comparison with the location of the fulcrum, load and effort in the resting position, the distance between the fulcrum and the effort (A′C) remains the same; however, the distance between the fulcrum and the load (A′B′) becomes shorter as a result of the movement of the lever pivot away from the punching end, and the movement of the point of contact between the longitudinal contact member and the punching members from the first end to the second end of the longitudinal contact member. A larger mechanical advantage is thus resulted.

The present invention enjoys a larger mechanical advantage in comparison with conventional paper punches with only one lever. This is because for such a conventional paper punch, the lever pivot is fixed in position in relation to both the lever and the punching members, so the distance between the lever pivot (fulcrum) and the point of contact between the lever and the punching members (load) remains unchanged in both the resting position and the punching position.

### BRIEF DESCRIPTION OF THE DRAWINGS

FIG. 1 is a disassembling view of a paper punch in accordance with the first embodiment of the present invention.

FIG. 2 is a perspective view of a vertical support mounted on the base of the first embodiment.

FIG. 3 is a disassembling view of the vertical support as shown in FIG. 2.

FIG. 4 is a cross-sectional view of the paper punch of FIG. 1 in a resting position.

FIG. 5 is another cross-sectional view of the paper punch similar to FIG. 4 illustrating the paper punch of FIG. 1 in a punching position.

FIG. 6 is a rear perspective view of the paper punch of FIG. 1.

FIG. 7 is a disassembling view of a paper punch in accordance with the second embodiment of the present invention.

FIG. 8 is a perspective view of a punching member of the paper punch of FIG. 7.

FIG. 9 is a disassembling view of a punching member as shown in FIG. 8.

FIGS. 10a and 10b are a cross-sectional view and a side view of the paper punch of FIG. 7 in a resting position respectively.

FIGS. 11a and 11b are a cross-sectional view and a side view of the paper punch of FIG. 7 as it moves from the resting position to the punching position respectively.

FIGS. 12a and 12b are a cross-sectional view and a side view of the paper punch of FIG. 7 in a punching position respectively.

FIG. 13 is a rear perspective view of the paper punch of FIG. 7.

### DETAILED DESCRIPTION OF THE INVENTION

The present invention is further described in detail below with reference to an embodiment and the accompanying drawings, but the present invention is not limited to the description therein.

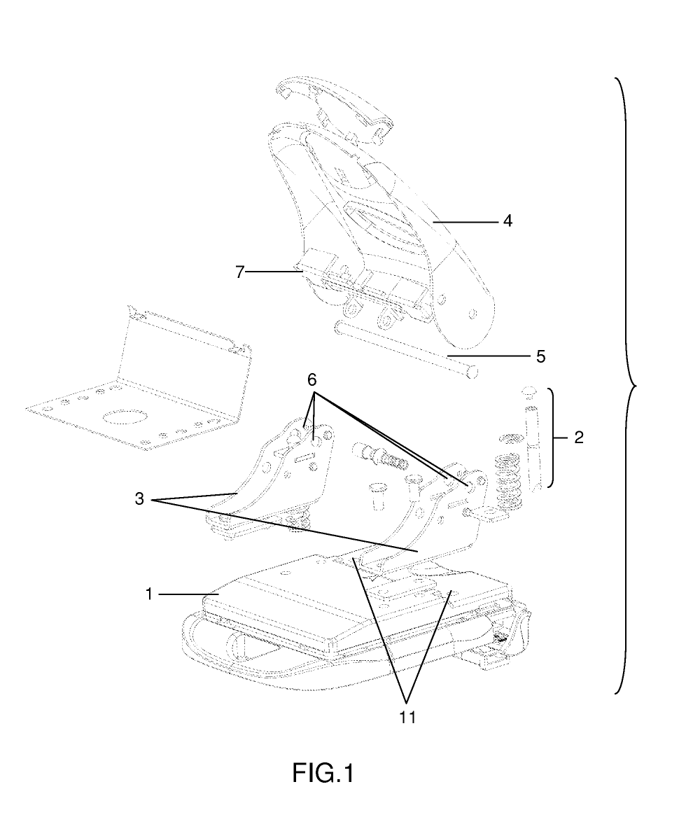

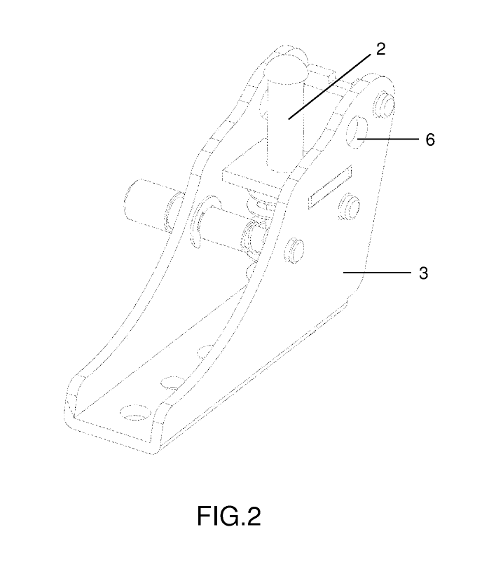

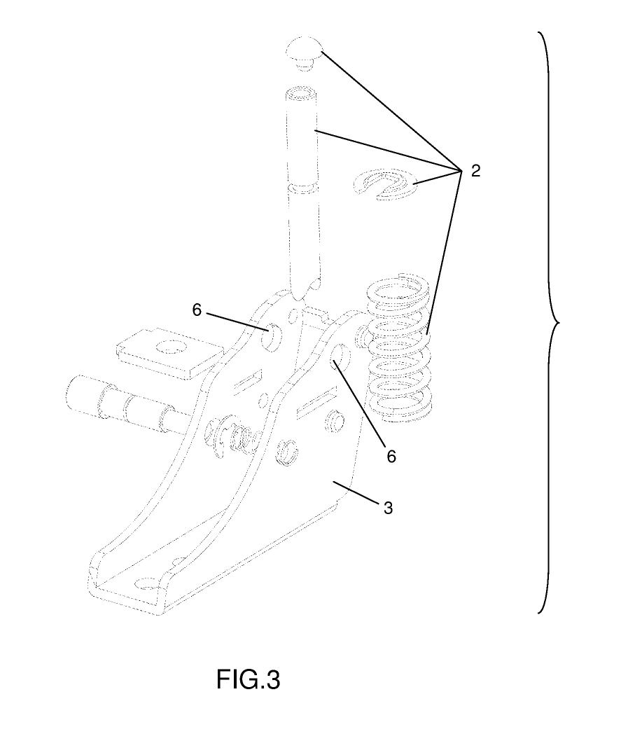

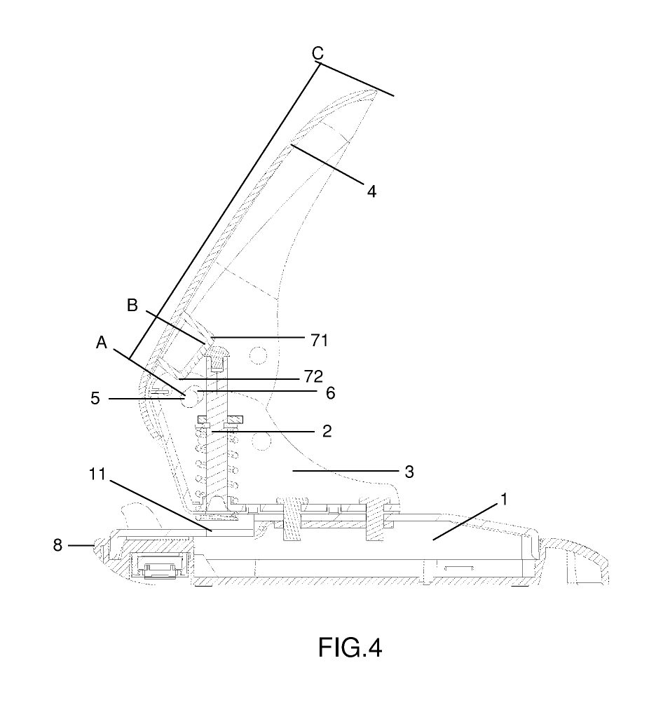

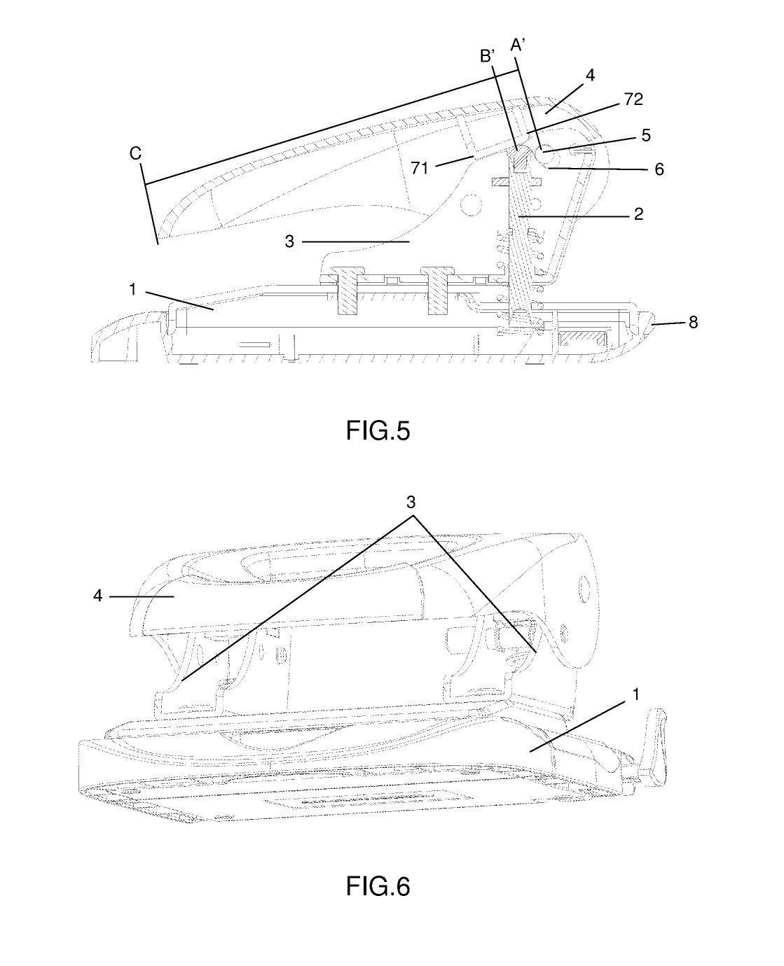

As shown in FIG. 1 to FIG. 6, the paper punch in accordance with a first embodiment of the present invention comprises a base 1, a plurality of spring-loaded punching members 2, a pair of vertical supports 3, a lever 4, a lever pivot 5, two lever pivot slots 6 provided at each of the vertical supports 3, and a longitudinal contact member 7 fixedly disposed underneath the lever 4.

The base 1 has a plurality of punching holes 11 disposed towards a punching end 8. The plurality of spring-loaded punching members 2 is disposed corresponding to the plurality of punching holes 11. The pair of vertical supports 3 is mounted on the base 1. Each of the vertical supports 3 encloses one of the spring-loaded punching members 2.

The lever 4 is pivotably connected to the pair of vertical supports 3 by means of the lever pivot 5 to pivot between a resting position and a punching position, and the lever pivot 5 is fixed in position in relation to the lever 4. The lever pivot 5 is received by the lever pivot slots 6. Each of the lever pivot slots 6 is slanted with its lower end disposed nearer the punching end 8 of the paper punch and its upper end disposed farther from the punching end 8 of the paper punch. The lever pivot slot 6 enables the lever pivot 5 to move towards the punching end 8 in the resting position and away from the punching end 8 in the punching position.

The longitudinal contact member 7 is fixedly disposed underneath the lever 4 at a position corresponding to the punching members 2 so that a first end 71 of the longitudinal contact member 7 which is farther away from the punching end 8 abuts against the punching members 2 in the resting position. As the lever 4 pivots from the resting position to the punching position, the first end 71 of the longitudinal contact member 7 moves farther away from the punching end 8 until a second end 72 of the longitudinal contact member 7 which is nearer to the punching end 8 abuts against the punching members 2 in the punching position. In the present embodiment, the longitudinal contact member 7 is in form of a U-shaped bracket mounted underneath the lever 4, and it is in form of an integral element with its lateral length sufficient to cover all punching members 2. In alternative embodiment (not shown), the longitudinal contact member may be in form of a U-shaped depression on the lever.

The operation of the present embodiment is as follows:

When the paper punch is in the resting position, the longitudinal contact member 7 is disposed with its first end 71 abutting against the top of the punching members 2, whereas the lever pivot 5 is located at one end of the lever pivot slot 6 which is nearer to the punching end 8. According to the lever principle, fulcrum is located at the position of the lever pivot 2 (A), load is located at the point of contact between the first end 71 of the longitudinal contact member 7 and the punching members 2 (B), and effort is located at the lever 4 end (C). Mechanical advantage is the ratio of the distance between fulcrum and effort (AC) to the distance between fulcrum and effort (AB), that is, AC/AB.

To start punching, the user presses the lever 4 end so that the lever 4 moves downwards to the punching position. As the lever 4 moves downwards, the lever pivot 5 is driven to move away from the punching end 8 towards the other end of the lever pivot slot 6. As the lever pivot 5 is fixed in position in relation to the lever 4, and the longitudinal contact member 7 is fixedly disposed underneath the lever 4, the longitudinal contact member 7 accordingly moves away from the punching end 8 until the second end 72 of the longitudinal contact member 7 abuts against the punching members 2. The punching members 2 at this time pass through the punching holes 11 and holes are punched on the sheets of paper. In the punching position, fulcrum is located at the position of the lever pivot (A′), load is located at the point of contact between the second end 72 of the longitudinal contact member 7 and the punching members (B′), and effort is located at the lever 4 end (C). In comparison with the location of the fulcrum, load and effort in the resting position, the distance between the fulcrum and the effort (A′C) remains the same; however, the distance between the fulcrum and the load (A′B′) becomes shorter as a result of the movement of the lever pivot 5 away from the punching end 8, and the movement of the point of contact between the longitudinal contact member 7 and the punching members 2 from the first end 71 to the second end 72 of the longitudinal contact member 7. A larger mechanical advantage is thus resulted.

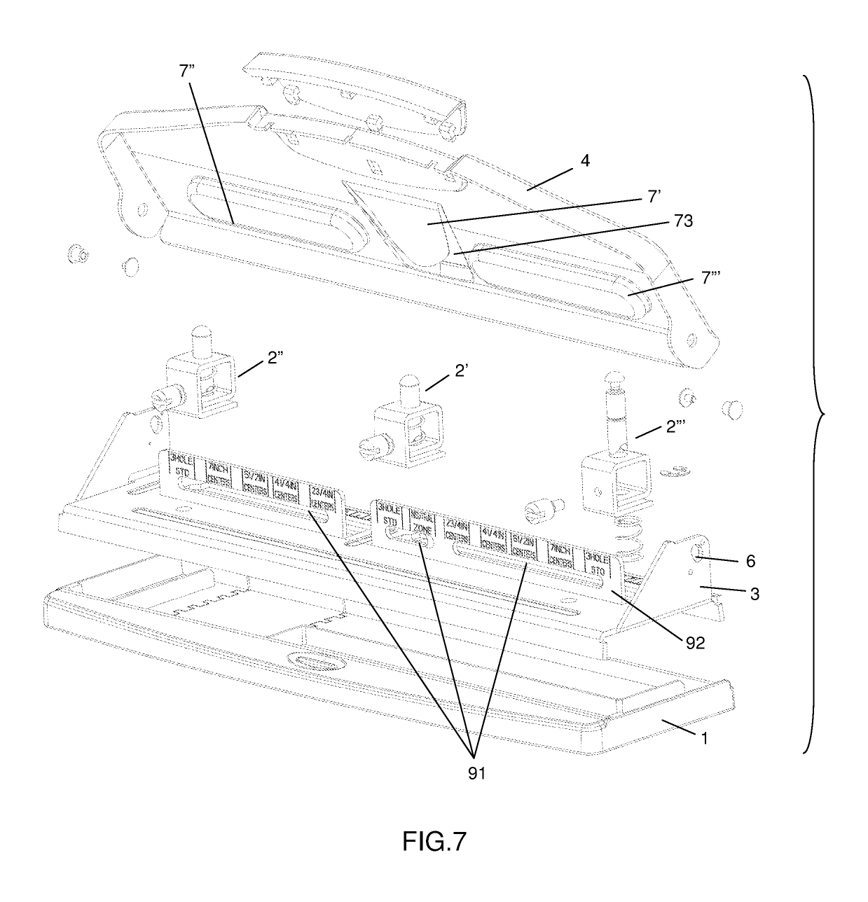

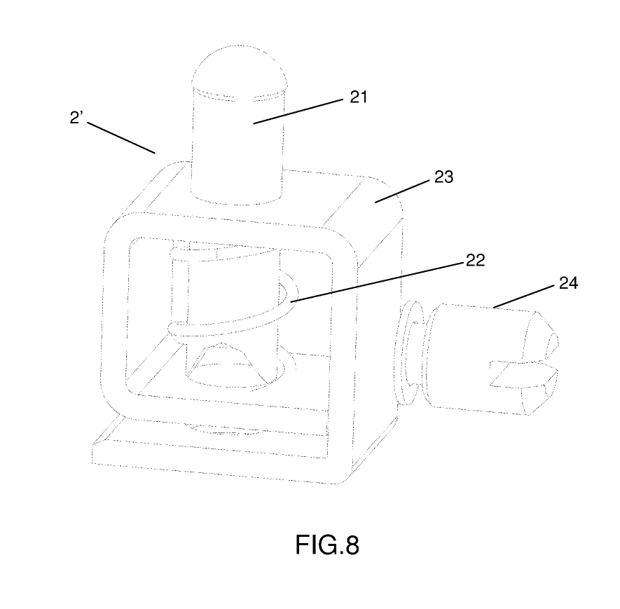

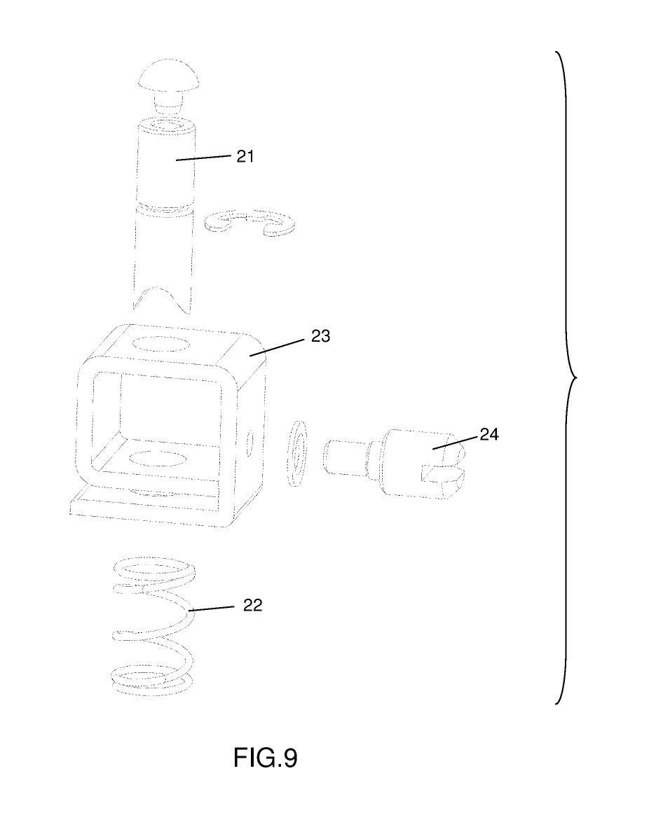

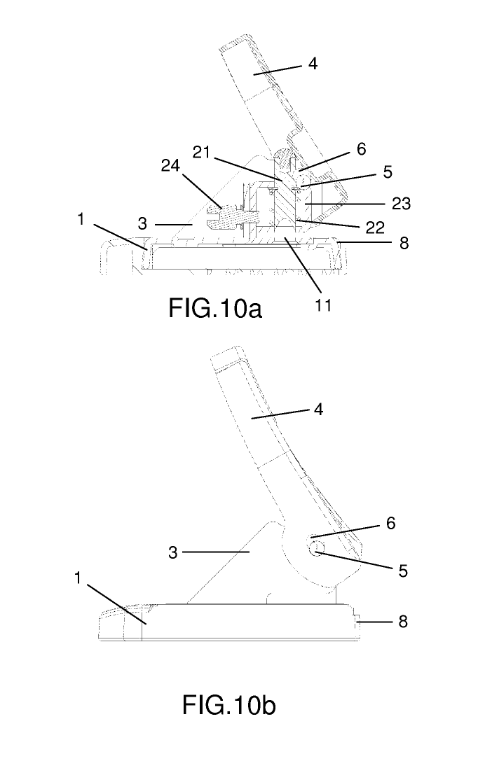

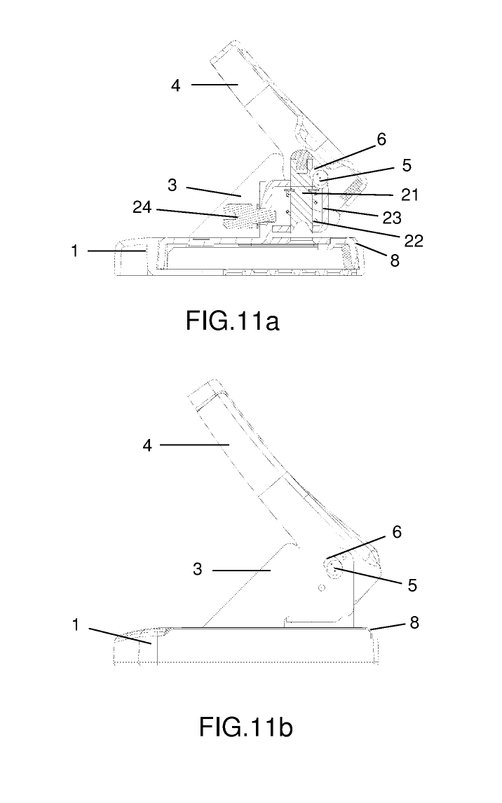

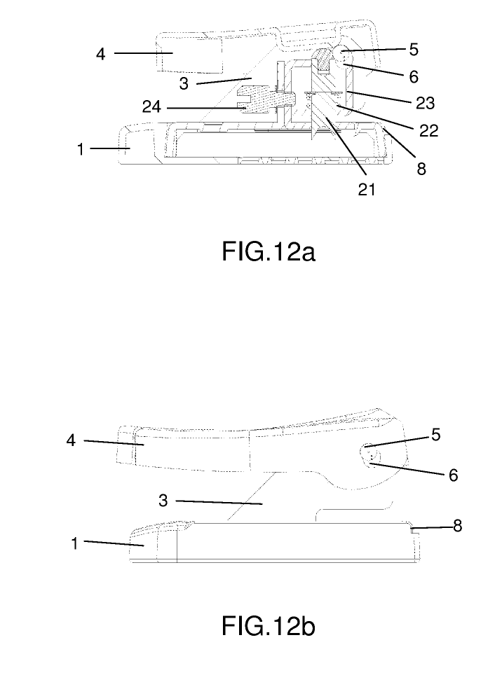

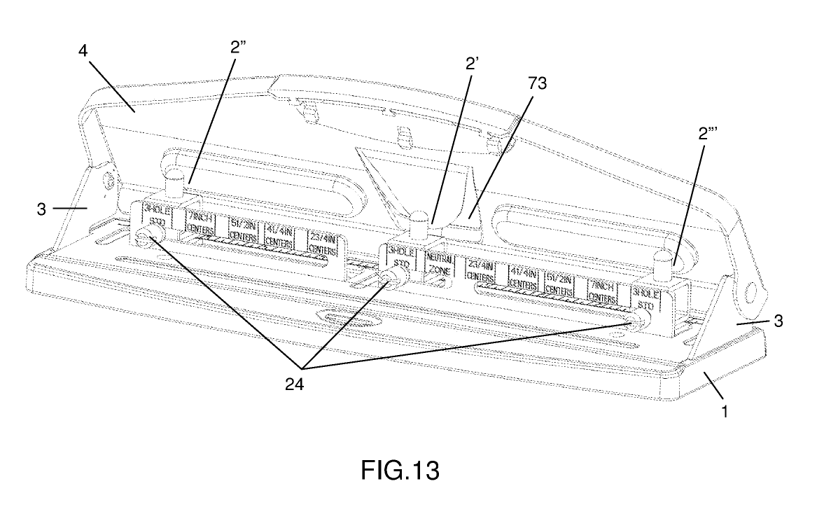

FIG. 7 to FIG. 13 illustrates a paper punch in accordance with a second embodiment of the present invention. The basic structure and the details of operation are basically similar to the paper punch of the first embodiment. Therefore, in the description of the second embodiment below, only the parts different from the first embodiment will be explained in detail.

In the second embodiment, there are three punching members 2′, 2″, 2′″. Each of the punching members 2′, 2″, 2′″ is horizontally adjustable in position; more specifically, each of the punching members 2′, 2″, 2′″ comprises a punch 21 loaded with spring 22, a bracket 23 for receiving the punch 21 and allowing the punch 21 to move vertically for punching, and a fastening member 24 removably attached to the bracket 23 and slidable along three horizontal guiding slots 91 provided on a guiding plate 92 mounted on the base 1 for moving the punching members 2′, 2″, 2′″ along the horizontal guiding slot 91. The punching holes 11 on the base 1 are configured correspondingly to allow the punching members 2′, 2″, 2′″ to punch at any possible positions. The fastening member 24 in this embodiment is in form of a screw. The guiding plate 92 is provided with dimensional markers to indicate corresponding punching positions.

In this embodiment, it is possible to punch only two holes instead of three holes even though there are three punching members 2′, 2″, 2′″. To attain this, the punching member in middle 2′ is horizontally slidable between an operational position and a non-operational position; the longitudinal contact member is in form of three separate elements of U-shaped depression 7′, 7″, 7′″ on the lever 4, each of which has a lateral length sufficient to cover one of the punching members 2′, 2″, 2′″. For the element of the longitudinal contact member 7′ corresponding to the punching member in middle 2′, it is configured to be in form of a protrusion extended from an opening 73 on the lever 4 so that the protrusion abuts against the punching member in middle 2′ when the punching member in middle 2′ is in the operational position, and the opening 73 corresponds in position to the punching member in middle 2′ so that the longitudinal contact member 7′ does not abut against the punching member in middle 2′ when the punching member in middle 2′ is in the non-operational position. Therefore, when the punching member in middle 2′ is in the non-operational position, even though the lever 4 is lowered, the punching member in middle 2′ will penetrate through the opening 73 and it will not be lowered to punch hole on the sheets of paper.

The present invention is not limited by the above embodiments. Any other changes, modification, substitution, combinations and simplification not deviated from the spiritual essence and principle of the present invention are equivalent replacement and they all fall into the scope of protection of the present invention.

What is claimed is:

1. An effort-saving paper punch which comprises
a base with a plurality of punching holes disposed towards a punching end;
a plurality of spring-loaded punching members disposed corresponding to the plurality of punching holes;
a pair of vertical supports mounted on the base;
a lever pivotably connected to the pair of vertical supports by means of a lever pivot to pivot between a resting position and a punching position, and the lever pivot is fixed in position in relation to the lever;
characterized in that:
a lever pivot slot is provided at each of the vertical supports for receiving the lever pivot in a way which enables the lever pivot to move towards the punching end in the resting position and away from the punching end in the punching position;
a longitudinal contact member is fixedly disposed underneath the lever at a position corresponding to the punching members so that a first end of the longitudinal contact member which is farther away from the punching end abuts against the punching members in the resting position; and as the lever pivots from the resting position to the punching position, the first end of the longitudinal contact member moves farther away from the punching end until a second end of the longitudinal contact member which is nearer to the punching end abuts against the punching members in the punching position.

2. The effort-saving paper punch as in claim 1, characterized in that the longitudinal contact member is in form of a U-shaped depression on the lever.

3. The effort-saving paper punch as in claim 1, characterized in that the longitudinal contact surface is in form of a U-shaped bracket mounted underneath the lever.

4. The effort-saving paper punch as in claim 1, characterized in that the longitudinal contact member is in form of an integral element with its lateral length sufficient to cover all punching members.

5. The effort-saving paper punch as in claim 1, characterized in that the longitudinal contact member is in form of separate elements, each of which has a lateral length sufficient to cover one of the punching members.

6. The effort-saving paper punch as in claim 1, characterized in that the lever slot is slanted with its lower end disposed nearer the punching end of the paper punch and its upper end disposed farther from the punching end of the paper punch.

7. The effort-saving paper punch as in claim 1, characterized in that each of the punching members is horizontally adjustable in position.

8. The effort-saving paper punch as in claim 1, characterized in that each of the punching members comprises a spring-loaded punch, a bracket for receiving the punch and allowing the punch to move vertically for punching, and a fastening member removably attached to the bracket and slidable along a horizontal guiding slot provided on a guiding plate mounted on the base for moving the punching member along the horizontal guiding slot; the punching holes on the base are configured correspondingly to allow the punching members to punch at any possible positions.

9. The effort-saving paper punch as in claim 8, characterized in that the fastening member is in form of a screw.

10. The effort-saving paper punch as in claim 8, characterized in that the guiding plate is provided with dimensional markers to indicate corresponding punching positions.

11. The effort-saving paper punch as in claim 1, characterized in that three punching members are provided; the punching member in middle is horizontally slidable between an operational position and a non-operational position; the longitudinal contact member is configured to abut against the punching member in middle when the punching member in middle is in the operational position, and not to abut against the punching member in middle when the punching member in middle is in the non-operational position.
